(19) United States
(12) Patent Application Publication
(10) Pub. No.: US 2012/0281447 A1
(43) Pub. Date: Nov. 8, 2012

(54) VOLTAGE CONVERTER AND METHOD OF PERFORMING VOLTAGE CONVERSION

(75) Inventors: DONG-HUN HEO, SEOUL (KR); SEUNG-CHUL SHIN, SEOUL (KR)

(73) Assignee: SAMSUNG ELECTRONICS CO., LTD., SUWON-SI (KR)

(21) Appl. No.: 13/438,189

(22) Filed: Apr. 3, 2012

(30) Foreign Application Priority Data
May 4, 2011 (KR) 10-2011-0042221

(51) Int. Cl. H02M 3/00

(52) U.S. Cl. 363/74

(57) ABSTRACT

A voltage converter includes a compensation unit, first and second control units, and an output voltage generation unit. The compensation unit selects compensation feedback voltage or output feedback voltage depending on an operation mode, and generates a compensation voltage based on the selected feedback voltage and a first reference voltage, the compensation feedback voltage corresponding to the compensation voltage, and the output feedback voltage corresponding to an output power supply voltage. The first control unit generates a first control signal based on the compensation voltage and a second reference voltage. The second control unit generates a second control signal based on the first reference voltage and the output feedback voltage. The output voltage generation unit selects one of the first control signal and the second control signal depending on the operation mode, and generates the output power supply voltage based on the selected control signal and an input voltage.

### CROSS-REFERENCE TO RELATED APPLICATION

A claim of priority under 35 U.S.C. §119 is made to Korean Patent Application No. 2011-0042221, filed on May 4, 2011, in the Korean Intellectual Property Office, the entire contents of which are hereby incorporated by reference.

### BACKGROUND

Various embodiments relate to a power supply, and more particularly, to a voltage converter and a power management device including the voltage converter, as well as a method of performing voltage conversion.

Generally, power supply devices are needed to supply voltage for operation of electronic devices. One type of power supply device is a voltage converter, one example of which is a DC-DC converter. DC-DC converters are used in many types of electronic devices to provide a stable power supply voltage. Pulse width modulation (PWM) has become a widely-used technique for controlling DC-DC converters by adjusting a current through an inductor.

### SUMMARY

Various embodiments provide a voltage converter and voltage conversion method capable of effectively providing a stable power supply voltage to an electronic device. Various embodiments provide a power management device including the voltage converter.

According to various embodiments, a voltage converter includes a compensation unit, a first control unit, a second control unit and an output voltage generation unit. The compensation unit is configured to select one of a compensation feedback voltage and an output feedback voltage depending on an operation mode, and to generate a compensation voltage based on the selected feedback voltage and a first reference voltage, the compensation feedback voltage corresponding to the compensation voltage, and the output feedback voltage corresponding to an output power supply voltage. The first control unit is configured to generate a first control signal based on the compensation voltage and a second reference voltage. The second control unit is configured to generate a second control signal based on the first reference voltage and the output feedback voltage. The output voltage generation unit is configured to select one of the first control signal and the second control signal depending on the operation mode, and to generate the output power supply voltage based on the selected control signal and an input voltage.

The operation mode may include a first operation mode and a second operation mode. The compensation unit may be configured to select the output feedback voltage and to compare the output feedback voltage with the first reference voltage to generate the compensation voltage in the first operation mode. The compensation unit may also be configured to select the compensation feedback voltage and to compare the compensation feedback voltage with the first reference voltage to generate the compensation voltage in the second operation mode.

The output voltage generation unit may be configured to select the first control signal and to generate the output power supply voltage based on the first control signal and the input voltage in the first operation mode. The output voltage generation unit may also be configured to select the second control signal and to generate the output power supply voltage based on the second control signal and the input voltage in the second operation mode.

An output terminal of the output voltage generation unit may be connected to a load unit driven based on the output power supply voltage. The voltage converter operates in the first operation mode when a level of a load current is higher than a reference current level, and the voltage converter operates in the second operation mode when the level of the load current is lower than the reference current level. The load current indicates a current flowing through the load unit.

The first operation mode may be a pulse width modulation (PWM) mode, and the first control signal may be a PWM signal. The second operation mode may be a pulse frequency modulation (PFM) mode, and the second control signal may be a PFM signal.

The compensation unit may include a selection unit and a frequency compensation unit. The selection unit is configured to select one of the compensation feedback voltage and the output feedback voltage based on a mode selection signal. The frequency compensation unit is configured to compare the selected feedback voltage with the first reference voltage, and to perform a frequency compensation operation on the selected feedback voltage to generate the compensation voltage.

The voltage converter may further include a mode selection unit configured to generate the mode selection signal based on a current flowing through the output voltage generation unit.

The first control unit may include a comparison unit and a latch unit. The comparison unit is configured to compare the compensation voltage with the second reference voltage to generate a comparison signal. The latch unit is configured to generate the first control signal based on a clock signal and the comparison signal. The second reference voltage may have an irregular waveform changing based on a current flowing through the output voltage generation unit.

The voltage converter may further include a sensing unit configured to detect a current flowing through the output voltage generation unit to generate a sensing voltage, and to output the sensing voltage as the second reference voltage.

The voltage converter may further include a ramp voltage generation unit configured to generate a ramp voltage, and to output the ramp voltage as the second reference voltage.

The output voltage generation unit may include a driving unit, an amplification unit and an output unit. The driving unit is configured to select one of the first control signal and the second control signal depending on the operation mode to generate gate driving signals. The amplification unit is configured to amplify the gate driving signals to generate amplified gate driving signals. The output unit is configured to convert the input voltage into the output power supply voltage in response to the amplified gate driving signals.

According to other embodiments, a power management device includes a reference voltage generator, a reset signal generator and a voltage converter. The reference voltage generator is configured to generate a reference voltage based on a power enable signal. The reset signal generator is configured to generate a reset signal based on the power enable signal and the reference voltage. The voltage converter is configured to provide an output power supply voltage, the voltage converter including a compensation unit, control units, and an output voltage generation unit. The compensation unit is configured to select one of a compensation feedback voltage and an output feedback voltage depending on an operation mode, and to generate a compensation voltage based on the selected feedback voltage and the reference voltage, the compensation feedback voltage corresponding to the compensation voltage, and the output feedback voltage corresponding to an output power supply voltage. The control units are configured to generate first and second control signals based on the compensation voltage, the reference voltage and the output feedback voltage. The output voltage generation unit is configured to generate the output power supply voltage based on an input voltage and a selected one of the first and second control signals.

The control units may include a first control unit configured to generate the first control signal based on the compensation voltage and a second reference voltage, and a second control unit configured to generate the second control signal based on the reference voltage and the output feedback voltage.

The operation mode may include a first operation mode and a second operation mode. The compensation unit is configured to select the output feedback voltage and to compare the output feedback voltage with the reference voltage to generate the compensation voltage in the first operation mode. The compensation unit is configured to select the compensation feedback voltage and to compare the compensation feedback voltage with the reference voltage to generate the compensation voltage in the second operation mode.

According to other embodiments, a method is provided for converting an input voltage to an output supply voltage for a load unit. The method includes determining an operation mode based on a mode selection signal, the mode selection signal being generated in response to a level of load current flowing through the load unit; selecting one of a compensation feedback voltage and an output feedback voltage depending on the operation mode, the compensation feedback voltage corresponding to a compensation voltage, and the output feedback voltage corresponding to the output supply voltage; and generating the output supply voltage based on the selected one of the compensation feedback voltage and the output feedback voltage and the input voltage.

Generating the output supply voltage based on the selected one of the compensation feedback voltage and the output feedback voltage may include generating the compensation voltage based on a first reference voltage and the selected one of the compensation feedback voltage and the output feedback voltage; generating first and second control signals based on the compensation voltage, the first reference voltage and a second reference voltage; selecting one of the first and second control signals depending on the operation mode; and generating the output supply voltage based on the selected control signal and the input voltage.

Generating first and second control signals may include generating the first control signal based on the compensation voltage and the second reference voltage, the first control signal being a PWM signal; and generating the second control signal based on the first reference voltage and the output feedback voltage, the second control signal being a PFM signal. When the level of the load current is higher than a reference current level, the operation mode may be a PWM mode and the first control signal is selected, and when the level of the load current is lower than the reference current level, the operation mode may be a PFM mode and the second control signal is selected.

Accordingly, the voltage converter according to various embodiments includes the compensation unit that generates the compensation voltage based on the output feedback voltage in the first operation mode, and based on the compensation feedback voltage (e.g., the compensation voltage itself) in the second operation mode. Thus, even when the operation mode is changed from the second operation mode to the first operation mode, the compensation voltage is not changed abruptly. Accordingly, for example, the voltage converter prevents sharp increasing of the current through the inductor, reduces overshoot of the output power supply voltage, and effectively generates the stable output power supply voltage.

### BRIEF DESCRIPTION OF THE DRAWINGS

Illustrative embodiments will be more clearly understood from the following detailed description taken in conjunction with the accompanying drawings.

FIG. 1 is a block diagram illustrating a voltage converter, according to exemplary embodiments.

FIG. 2 is a block diagram illustrating an example of a compensation unit included in the voltage converter of FIG. 1.

FIG. 3 is a block diagram illustrating an example of a first control unit included in the voltage converter of FIG. 1.

FIG. 4 is a block diagram illustrating an example of an output voltage generation unit included in the voltage converter of FIG. 1.

FIG. 5 is a block diagram illustrating a voltage converter, according to exemplary embodiments.

FIGS. 6A and 6B are diagrams for comparing operations of a conventional voltage converter and a voltage converter according to exemplary embodiments.

FIG. 7 is a block diagram illustrating a voltage converter, according to other exemplary embodiments.

FIG. 8 is a diagram for describing an operation of the voltage converter of FIG. 7.

FIG. 9 is a flow chart illustrating a method of operating a voltage converter, according to exemplary embodiments.

FIG. 10 is a flow chart illustrating an example of step 5200 in FIG. 9, according to exemplary embodiments.

FIG. 11 is a block diagram illustrating a power management device, according to exemplary embodiments.

FIG. 12 is a block diagram illustrating a power management system, according to exemplary embodiments.

FIG. 13 is a block diagram illustrating a power management system, according to other exemplary embodiments.

FIG. 14 is a block diagram illustrating a mobile system, according to exemplary embodiments.

FIG. 15 is a block diagram illustrating a computing system, according to exemplary embodiments.

### DETAILED DESCRIPTION OF THE EMBODIMENTS

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms first, second, etc., may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items. Also, the term “exemplary” is intended to refer to an example or illustration.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

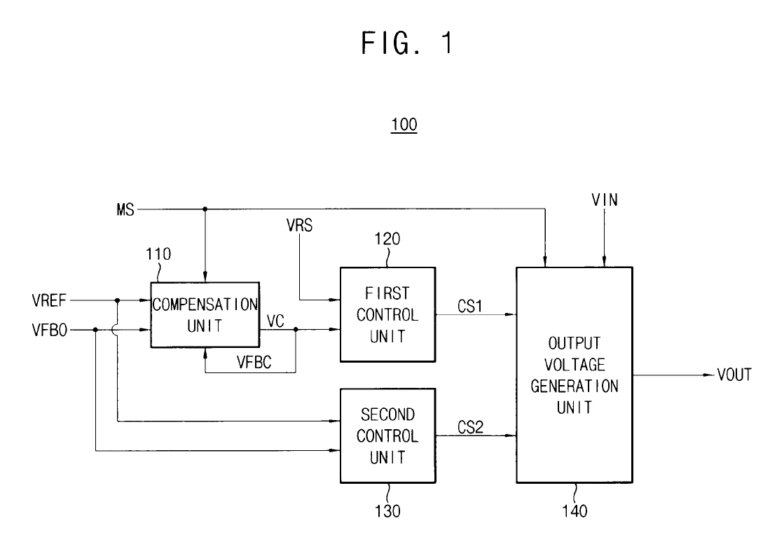

FIG. 1 is a block diagram illustrating a voltage converter, according to exemplary embodiments.

A voltage converter 100 converts an input voltage VIN into a stable output power supply voltage VOUT. When the input voltage VIN and the output power supply voltage VOUT are direct current (DC) voltages, respectively, the voltage converter 100 is a DC-DC converter. Hereinafter, the various embodiments are described assuming that the voltage converter 100 is a DC-DC converter, for example. However, the voltage converter 100 may be one of various other types of voltage converters without departing from the scope of the present teachings.

Referring to FIG. 1, the voltage converter 100 includes a compensation unit 110, a first control unit 120, a second control unit 130 and an output voltage generation unit 140. The compensation unit 110 selects one of a compensation feedback voltage VFBC and an output feedback voltage VFBO depending on an operation mode, and generates a compensation voltage VC based on the selected feedback voltage and a first reference voltage VREF. For example, the compensation unit 110 may select one of the compensation feedback voltage VFBC and the output feedback voltage VFBO based on a mode selection signal MS.

The compensation feedback voltage VFBC corresponds to the compensation voltage VC. For example, the compensation feedback voltage VFBC may be the compensation voltage VC itself. The output feedback voltage VFBO corresponds to the output power supply voltage VOUT. For example, the output feedback voltage VFBO may be the output power supply voltage VOUT itself or a voltage obtained by dividing the output power supply voltage VOUT by a predetermined ratio. The first reference voltage VREF may be a stabilized voltage, and may be set such that the compensation voltage VC corresponds to a target level. The voltage converter 100 may receive the first reference voltage VREF from a voltage generator (not shown).

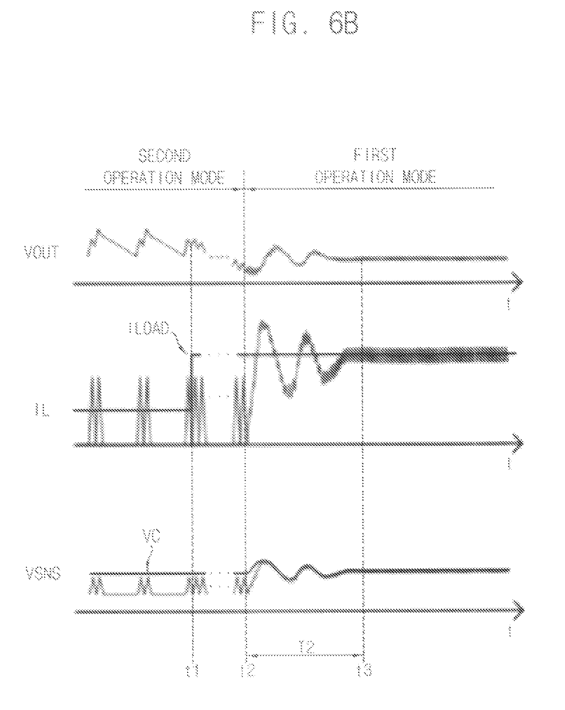

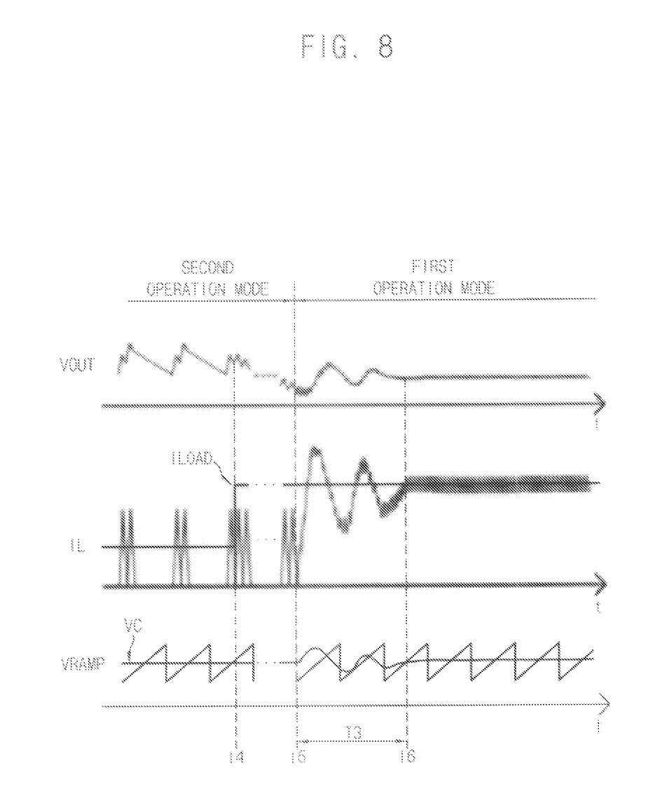

The first control unit 120 generates a first control signal CS1 based on the compensation voltage VC and a second reference voltage VRS. According to exemplary embodiments, the second reference voltage VRS may have one of various waveforms. For example, as described below with reference to FIG. 6B, the second reference voltage VRS may have an irregular waveform that changes based on a current flowing through the output voltage generation unit 140. For another example, as described below with reference to FIG. 8, the second reference voltage VRS may have a regular waveform regardless of the current flowing through the output voltage generation unit 140. The second control unit 130 generates a second control signal CS2 based on the first reference voltage VREF and the output feedback voltage VFBO.

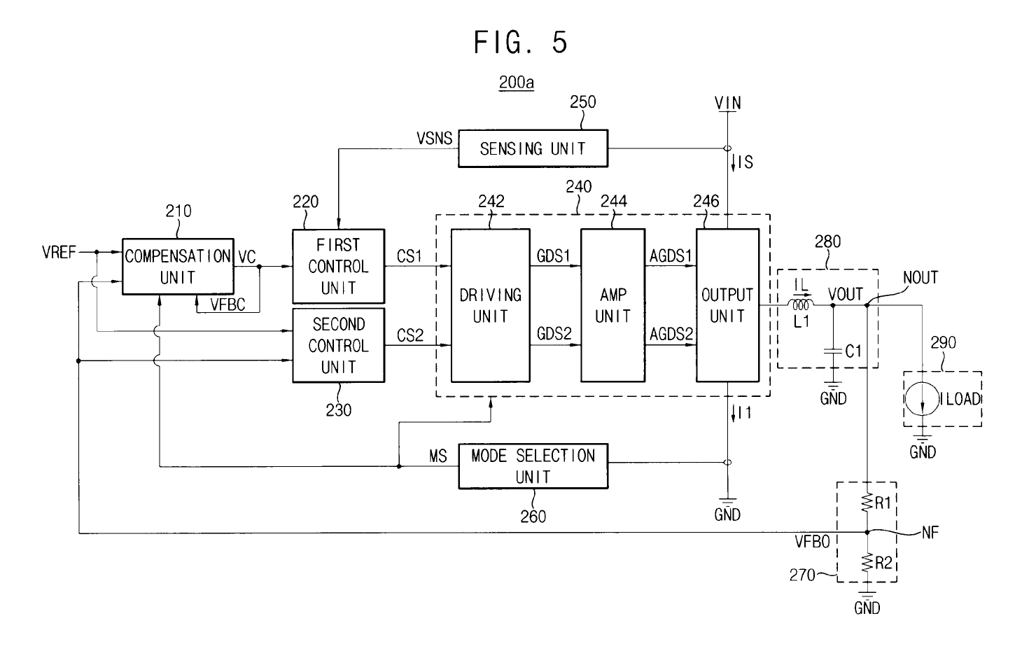

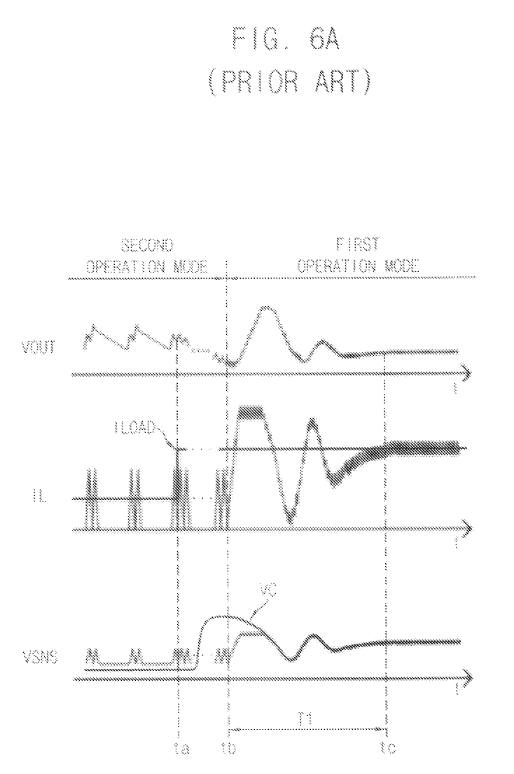

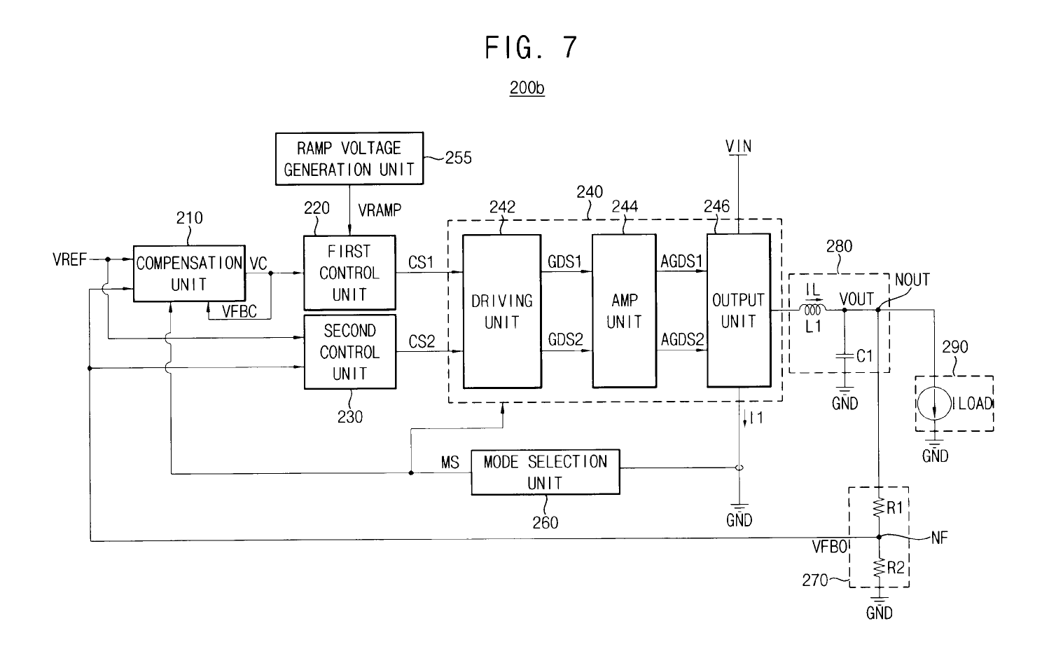

The output voltage generation unit 140 selects one of the first control signal CS1 and the second control signal CS2 depending on the operation mode, and generates the output power supply voltage VOUT based on the selected control signal and the input voltage VIN. The output voltage generation unit 140 may include semiconductor devices, such as metal oxide semiconductor field effect transistors (MOSFETs). The output voltage generation unit 140 may convert the DC input voltage VIN into the stable DC output power supply voltage VOUT by controlling a current through an inductor, using the semiconductor devices as switching devices. As described below with reference to FIGS. 5 and 7, the inductor may be included in a filter unit that is connected to an output terminal of the output voltage generation unit 140.

The voltage converter 100 may be implemented as a dual mode voltage converter. The operation mode of the voltage converter 100 includes a first operation mode and a second operation mode. The first operation mode may be referred to as a heavy load driving mode, and the second operation mode may be referred to as a light load driving mode, for example. Although not illustrated in FIG. 1, the output terminal of the output voltage generation unit 140 may be connected to a load unit that is driven based on the output power supply voltage VOUT. The operation mode of the voltage converter 100 may be determined depending on a level of a load current that indicates a current flowing through the load unit. For example, when the level of the load current is higher than a reference current level (e.g., when the level of the output power supply voltage VOUT is lower than a predetermined voltage level), the voltage converter 100 operates in the first operation mode. When the level of the load current is lower than the reference current level (e.g., when the level of the output power supply voltage VOUT is higher than the predetermined voltage level), the voltage converter 100 operates in the second operation mode.

In an embodiment, the first operation mode may be a pulse width modulation (PWM) mode, and the first control signal CS1 may be a PWM signal. The voltage converter 100 effectively controls the current through the inductor based on the PWM signal in the first operation mode. The voltage converter 100 has relatively low power consumption when the load current has a relatively high level (e.g., when the level of the load current is higher than the reference current level).

In an embodiment, the second operation mode may be a pulse frequency modulation (PFM) mode, and the second control signal CS2 may be a PFM signal. The voltage converter 100 effectively controls the current through the inductor based on the PFM signal in the second operation mode. The voltage converter 100 has relatively low power consumption by reducing a switching frequency of the semiconductor devices included in the output voltage generation unit 140 when the load current has relatively low level (e.g., when the level of the load current is lower than the reference current level). In another embodiment, the second operation mode may be one of various operation modes that reduce power consumption of the voltage converter 100 when the load current has a relatively low level.

To reduce power consumption of the voltage converter 100, the first control unit 120 and the second control unit 130 may be selectively enabled depending on the operation mode. For example, in the first operation mode, the first control unit 120 may be enabled and the second control unit 130 may be disabled. In the second operation mode, the second control unit 130 may be enabled and the first control unit 120 may be disabled.

In a conventional dual mode voltage converter, when an operation mode of the conventional voltage converter is changed from a light load driving mode (e.g., a PFM mode) to a heavy load driving mode (e.g., a PWM mode), a compensation voltage generated by a compensation unit changes abruptly (e.g., sharply increases). Due to the sharply increasing compensation voltage, current through an inductor sharply increases, an output power supply voltage sharply increases, and thus an overshoot of the output power supply voltage occurs at a transition time of the operation mode. The overshoot of the output power supply voltage may damage the other circuits driven by the output power supply voltage.

In the voltage converter 100, the compensation unit 110 selects one of the compensation feedback voltage VFBC and the output feedback voltage VFBO depending on the operation mode, and generates the compensation voltage VC based on the selected feedback voltage and the first reference voltage VREF. Even when the operation mode of the voltage converter 100 is changed from the second operation mode (e.g., the PFM mode) to the first operation mode (e.g., the PWM mode), the compensation unit 110 prevents abrupt changes (e.g., sharp increases) of the compensation voltage VC. Accordingly, the voltage converter 100 prevents abrupt changes (e.g., sharp increases) of a current through an inductor, reduces an overshoot of the output power supply voltage VOUT, and effectively generates the stable output power supply voltage VOUT.

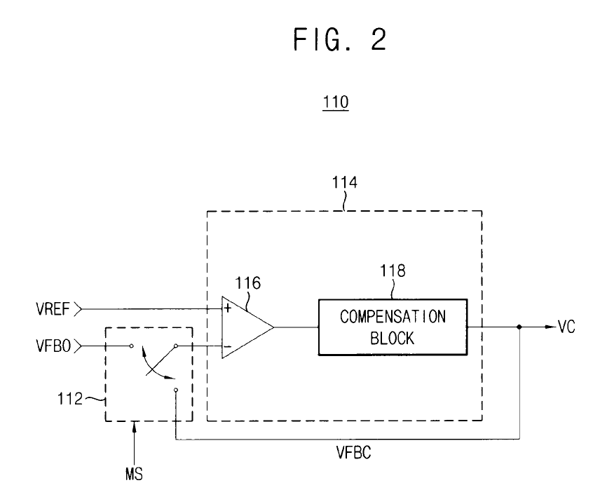

FIG. 2 is a block diagram illustrating an example of a compensation unit included in the voltage converter of FIG. 1.

Referring to FIG. 2, the compensation unit 110 includes a selection unit 112 and a frequency compensation unit 114. The selection unit 112 selects one of the compensation feedback voltage VFBC and the output feedback voltage VFBO based on the mode selection signal MS. As described below with reference to FIGS. 5 and 7, the mode selection signal MS may be generated based on the current flowing through the output voltage generation unit 140, and may indicate the operation mode of the voltage converter 100. The current flowing through the output voltage generation unit 140 may correspond to the load current that flows through the load unit connected to the output terminal of the output voltage generation unit 140, and may correspond to the level of the output power supply voltage VOUT.

When the amount of current flowing through the output voltage generation unit 140 is relatively large (e.g., when the level of the load current is higher than the reference current level, and the level of the output power supply voltage VOUT is lower than the predetermined voltage level), the mode selection signal MS has a first logic level and the voltage converter 100 operates in the first operation mode. When the amount of current flowing through the output voltage generation unit 140 is relatively small (e.g., when the level of the load current is lower than the reference current level, and the level of the output power supply voltage VOUT is higher than the predetermined voltage level), the mode selection signal MS has a second logic level and the voltage converter 100 operates in the second operation mode. The first logic level may be a logic low level and the second logic level may be a logic high level, for example.

In an embodiment, when the voltage converter 100 operates in the first operation mode, the selection unit 112 selects the output feedback voltage VFBO, and provides the output feedback voltage VFBO to the frequency compensation unit 114. When the voltage converter 100 operates in the second operation mode, the selection unit 112 selects the compensation feedback voltage VFBC, and provides the compensation feedback voltage VFBC to the frequency compensation unit 114. The selection unit 112 may be a switch that selectively outputs one of the compensation feedback voltage VFBC and the output feedback voltage VFBO, for example.

The frequency compensation unit 114 compares the selected feedback voltage with the first reference voltage VREF, and performs a frequency compensation operation on the selected feedback voltage to generate the compensation voltage VC. For example, in the first operation mode, the frequency compensation unit 114 compares the output feedback voltage VFBO with the first reference voltage VREF, and performs the frequency compensation operation on the output feedback voltage VFBO to determine the level of the compensation voltage VC. In the second operation mode, the frequency compensation unit 114 compares the compensation feedback voltage VFBC with the first reference voltage VREF, and performs the frequency compensation operation on the compensation feedback voltage VFBC to determine the level of the compensation voltage VC.

In the depicted embodiment, the frequency compensation unit 114 includes a comparator 116 and a compensation block 118. The comparator 116 compares the selected feedback voltage with the first reference voltage VREF to generate a comparison result. For example, the comparator 116 may have a first input terminal receiving the first reference voltage VREF, a second input terminal receiving the selected feedback voltage, and an output terminal outputting the comparison result. The compensation block 118 generates a frequency compensated voltage signal based on the comparison result. The frequency compensated voltage signal may be referred to the compensation voltage VC. Although not illustrated in FIG. 2, the compensation block 118 may include a first resistor and a capacitor connected in series between the output terminal of the comparator 116 and the second input terminal of the comparator 116, and may include a second resistor connected between the second input terminal of the comparator 116 and the switch included in the selection unit 112. In other words, the frequency compensation unit 114 may be implemented as an integrator that includes the comparator 116, the first resistor, the second resistor and the capacitor.

The compensation unit 110 of FIG. 2 may generate the compensation voltage VC based on the output feedback voltage VFBO in the first operation mode (e.g., the PWM mode), and based on the compensation feedback voltage VFBC (e.g., the compensation voltage VC itself) in the second operation mode (e.g., the PFM mode). In the second operation mode, the compensation unit 110 operates as a buffer with a negative feedback control, and the level of the compensation voltage VC may be substantially the same as a level of the first reference voltage VREF. Thus, even when the operation mode of the voltage converter 100 is changed from the second operation mode (e.g., the PFM mode) to the first operation mode (e.g., the PWM mode), the level of the compensation voltage VC starts to change (e.g., increase) from the level of the first reference voltage VREF. Accordingly, the compensation voltage VC is not changed abruptly (e.g., increased sharply), and the voltage converter 100 including the compensation unit 110 prevents abrupt changes (e.g., increased sharply) of the current through the inductor, and reduces the overshoot of the output power supply voltage VOUT.

Although it is explained that the compensation unit 110 has a gain of about one in the second operation mode, in other words, the ratio of an input voltage (e.g., the first reference voltage VREF) to an output voltage (e.g., the compensation voltage VC) of the compensation unit 110 is about one in the second operation mode with reference to FIG. 2, the gain of the compensation unit 110 in the second operation mode is not limited thereto.

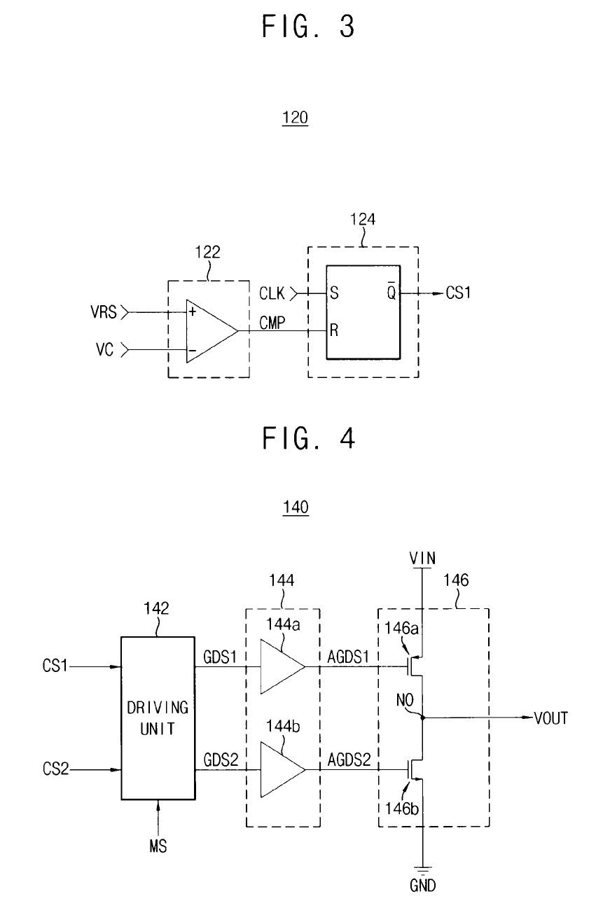

FIG. 3 is a block diagram illustrating an example of a first control unit included in the voltage converter of FIG. 1.

Referring to FIG. 3, the first control unit 120 includes a comparison unit 122 and a latch unit 124. The comparison unit 122 compares the compensation voltage VC with the second reference voltage VRS to generate a comparison signal CMP. In the depicted embodiment, the comparison unit 122 includes a comparator that has a first input terminal receiving the second reference voltage VRS, a second input terminal receiving the compensation voltage VC, and an output terminal outputting the comparison signal CMP.

The latch unit 124 generates the first control signal CS1 based on a clock signal CLK and the comparison signal CMP. In the depicted embodiment, the latch unit 124 includes an SR latch that has a first input terminal receiving the clock signal CLK, a second input terminal receiving the comparison signal CMP, and an inversion output terminal outputting the first control signal CS1.

FIG. 4 is a block diagram illustrating an example of an output voltage generation unit included in the voltage converter of FIG. 1.

Referring to FIG. 4, the output voltage generation unit 140 includes a driving unit 142, an amplification unit 144 and an output unit 146. The driving unit 142 selects one of the first control signal CS1 and the second control signal CS2 depending on the operation mode to generate gate driving signals GDS1 and GDS2. For example, the driving unit 142 may select one of the first control signal CS1 and the second control signal CS2 based on the mode selection signal MS. When the voltage converter 100 operates in the first operation mode (e.g., when the mode selection signal MS has the first logic level), the driving unit 142 generates the gate driving signals GDS1 and GDS2 based on the first control signal CS1. When the voltage converter 100 operates in the second operation mode (e.g., when the mode selection signal MS has the second logic level), the driving unit 142 generates the gate driving signals GDS1 and GDS2 based on the second control signal CS2.

The amplification unit 144 amplifies the gate driving signals GDS1 and GDS2 to generate amplified gate driving signals AGDS1 and AGDS2. In the depicted embodiment, the amplification unit 144 includes a first amplifier 144a and a second amplifier 144b. The first amplifier 144a amplifies the first gate driving signal GDS1 to generate a first amplified gate driving signal AGDS1. The second amplifier 144b amplifies the second gate driving signal GDS2 to generate a second amplified gate driving signal AGDS2.

The output unit 146 converts the input voltage VIN into the output power supply voltage VOUT in response to the amplified gate driving signals AGDS1 and AGDS2. The output unit 146 may include a first transistor 146a and a second transistor 146b. The first transistor 146a is connected between the input voltage VIN and an output node NO, and has a control electrode (e.g., a gate electrode) for receiving the first amplified gate driving signal AGDS1. The second transistor 146b is connected between the output node NO and a ground voltage GND, and has a control electrode (e.g., a gate electrode) for receiving the second amplified gate driving signal AGDS2. The output unit 146 generates the output power supply voltage VOUT that has a fixed voltage level, by controlling on-times and off-times of the transistors 146a and 146b in response to the amplified gate driving signals AGDS1 and AGDS2.

Assuming that the first operation mode is the PWM mode, the second operation mode is the PFM mode, the first control signal CS1 is a PWM signal, and the second control signal CS2 is a PFM signal. In the first operation mode, the output power supply voltage VOUT may have the fixed voltage level by adjusting a duty cycle of the first control signal CS1. For example, when the output power supply voltage VOUT increases, the compensation voltage VC decreases, the duty ratio of the first control signal CS1 decreases, the on-times of the transistors 146a and 146b decreases, and thus the output power supply voltage VOUT decreases to maintain the fixed voltage level. Conversely, when the output power supply voltage VOUT decreases, the compensation voltage VC increases, the duty ratio of the first control signal CS1 increases, the on-times of the transistors 146a and 146b increases, and thus the output power supply voltage VOUT increases to maintain the fixed voltage level. Similarly, in the second operation mode, the output power supply voltage VOUT maintains a fixed voltage level by adjusting frequency of the second control signal CS2.

FIG. 5 is a block diagram illustrating a voltage converter, according to exemplary embodiments.

Referring to FIG. 5, a voltage converter 200a includes a compensation unit 210, a first control unit 220, a second control unit 230 and an output voltage generation unit 240. The voltage converter 200a further includes a sensing unit 250, a mode selection unit 260, a feedback unit 270, a filter unit 280 and a load unit 290.

The compensation unit 210, the first control unit 220, the second control unit 230 and the output voltage generation unit 240 may be substantially the same as the compensation unit 110, the first control unit 120, the second control unit 130 and the output voltage generation unit 140 in FIG. 1, respectively. The compensation unit 210 selects one of a compensation feedback voltage VFBC and an output feedback voltage VFBO depending on the operation mode (e.g., based on a mode selection signal MS), and generates a compensation voltage VC based on the selected feedback voltage and a first reference voltage VREF. The first control unit 220 generates a first control signal CS1 based on the compensation voltage VC and a second reference voltage (e.g., a sensing voltage VSNS). The second control unit 230 generates a second control signal CS2 based on the first reference voltage VREF and the output feedback voltage VFBO. The output voltage generation unit 240 selects one of the first control signal CS1 and the second control signal CS2 depending on the operation mode (e.g., based on the mode selection signal MS), and generates an output current IL based on the selected control signal and the input voltage VIN. The output current IL may be a current flowing through an inductor L1 of the filter unit 280. The output power supply voltage VOUT is induced based on the output current IL flowing through the inductor L1.

In the depicted embodiment, the output voltage generation unit 240 includes a driving unit 242, an amplification unit 244 and an output unit 246. The driving unit 242, the amplification unit 244 and the output unit 246 may be substantially the same as the driving unit 142, the amplification unit 144 and the output unit 146 in FIG. 4, respectively. The driving unit 242 may select one of the first control signal CS1 and the second control signal CS2 depending on the operation mode (e.g., based on the mode selection signal MS) to generate gate driving signals GDS1 and GDS2. The amplification unit 244 may amplify the gate driving signals GDS1 and GDS2 to generate amplified gate driving signals AGDS1 and AGDS2. The output unit 246 converts the input voltage VIN into the output current IL in response to the amplified gate driving signals AGDS1 and AGDS2.

The sensing unit 250 may detect current IS to generate the sensing voltage VSNS, and outputs the sensing voltage VSNS as the second reference voltage. The current IS corresponds to the current flowing through the output voltage generation unit 240. In this case, the voltage converter 200a may be implemented by a current driving scheme such that the voltage converter 200a operates based on the current IS. The sensing voltage VSNS may have an irregular waveform that changes based on the current IS. Although not illustrated in FIG. 5, the sensing unit 250 may include a first detection unit and a first gain control unit, each of which has at least one resistor and at least one transistor. The first detection unit may detect the current IS to generate a first current detecting signal. The first gain control unit may convert the first current detecting signal into the sensing voltage VSNS.

The mode selection unit 260 generates the mode selection signal MS based on current I1, which corresponds to the current flowing through the output voltage generation unit 240. As described above with reference to FIG. 2, the operation mode of the voltage converter 200a is determined depending on the logic level of the mode selection signal MS. For example, when the amount of current I1 is relatively large (e.g., when the level of a load current ILOAD through load unit 290 is higher than a reference current level), the mode selection signal MS has the first logic level and the voltage converter 200a operates in the first operation mode. When the amount of current I1 is relatively small (e.g., when the level of the load current ILOAD is lower than the reference current level), the mode selection signal MS has the second logic level and the voltage converter 200a operates in the second operation mode. Although not illustrated in FIG. 5, the mode selection unit 260 may include a second detection unit and a second gain control unit, each of which has at least one resistor and at least one transistor. The second detection unit detects the current I1 to generate a second current detecting signal. The second gain control unit converts the second current detecting signal into the mode selection signal MS.

The feedback unit 270 generates the output feedback voltage VFBO by dividing the output power supply voltage VOUT by a predetermined ratio, and provides the output feedback voltage VFBO to the compensation unit 210. In the depicted embodiment, the feedback unit 270 includes a first resistor R1 and a second resistor R2 that are connected in series between an output node NOUT and a ground voltage GND. The output feedback voltage VFBO is determined depending on a ratio of a resistance of the first resistor R1 and a resistance of the second resistor R2. A voltage at a feedback node NF between the first resistor R1 and the second resistor R2 corresponds to the output feedback voltage VFBO.

The filter unit 280 generates and stores an electric energy based on the output current IL, and outputs the output power supply voltage VOUT. The filter unit 280 may be implemented as a low-pass filter, for example, including an inductor L1 and a capacitor C1. Assuming that the output unit 246 is substantially the same as the output unit 146 in FIG. 4, when the first transistor 146a is turned on and the second transistor 146b is turned off, a current corresponding to the input voltage VIN flows through the first transistor 146a, the inductor L1, and the capacitor C1. When the first transistor 146a is turned off and the second transistor 146b is turned on, the current flows to the ground electrode through the second transistor 146b.

The load unit 290 is one of various electronic circuits and/or electronic devices that are driven based on the output power supply voltage VOUT from the voltage converter 200a. The operation mode of the voltage converter 200a is determined depending on the level of the load current ILOAD through the load unit 290.

Although not illustrated in FIG. 5, the voltage converter 200a may further include a reference voltage generation unit and an overcurrent protection unit. The reference voltage generation unit (not shown) may generate the first reference voltage VREF. The overcurrent protection unit (not shown) may prevent the current IS from overly increasing, even though the level of the input voltage VIN increases.

FIGS. 6A and 6B are diagrams for describing operation of the voltage converter according to various exemplary embodiments. FIG. 6A illustrates current and voltage variations in a conventional voltage converter. FIG. 6B illustrates current and voltage variations depending on operation mode in the voltage converter 200a of FIG. 5.

Referring to FIG. 6A, the amount of load current ILOAD initially flowing through a load unit is relatively small. In other words, the level of load current ILOAD is lower than a reference current level, and the level of an output power supply voltage VOUT is higher than a predetermined voltage level. The conventional voltage converter operates in a second operation mode (e.g., a PFM mode).

Referring to FIG. 6A, at time ta, the load current ILOAD increases. Since the level of the load current ILOAD is higher than the reference current level (e.g., a desired maximum current level in the PFM mode), the output power supply voltage VOUT starts to decrease. As the output power supply voltage VOUT decreases, a compensation voltage VC sharply increases.

At time tb, since the level of the output power supply voltage VOUT is lower than the predetermined voltage level, the conventional voltage converter operates in a first operation mode (e.g., a PWM mode). Due to the sharp increase of the compensation voltage VC, the difference between the compensation voltage VC and a second voltage (e.g., sensing voltage VSNS) is relatively large. It is difficult to effectively generate a first control signal CS1 (e.g., a PWM signal) because of the difference between the compensation voltage VC and the sensing voltage VSNS. A duty cycle of the first control signal is abnormally adjusted until the level of the compensation voltage VC corresponds to a predetermined normal range. Thus, current IL flowing through an inductor sharply increases and an overshoot of the output power supply voltage VOUT occurs.

At time tc, the current IL and the output power supply voltage VOUT are stabilized. As illustrated in FIG. 6A, in the conventional voltage converter, the approximate time required to stabilize the output power supply voltage VOUT is indicated by T1.

Referring to FIGS. 5 and 6B, the amount of load current ILOAD initially flowing through the load unit 290 is relatively small. In other words, the level of the load current ILOAD is lower than the reference current level, and the level of the output power supply voltage VOUT is higher than the predetermined voltage level. The voltage converter 200a operates in the second operation mode (e.g., the PFM mode). In the second operation mode, the compensation voltage VC has the level of the first reference voltage VREF, according to the negative feedback control of the compensation unit 210.

At time t1, the load current ILOAD increases. Since the level of the load current ILOAD is higher than the reference current level (e.g., the desired maximum current level in the PFM mode), the output power supply voltage VOUT starts to decrease. During a time period from time t1 to time t2, even if the level of the load current ILOAD is higher than the reference current level, the voltage converter 200a still operates in the second operation mode until time t2 before the level of the output power supply voltage VOUT is lower than the predetermined voltage level. Even when the output power supply voltage VOUT decreases, the compensation voltage VC still has the level of the first reference voltage VREF according to the negative feedback control of the compensation unit 210.

At time t2, since the level of the output power supply voltage VOUT is lower than the predetermined voltage level, the voltage converter 200a operates in the first operation mode (e.g., the PWM mode). In this case, the compensation voltage VC starts to increase from the level of the first reference voltage VREF. In comparison with FIG. 6A, the difference between the compensation voltage VC and the second voltage (e.g., the sensing voltage VSNS) is relatively small in FIG. 6B, and the time required to stabilize the compensation voltage VC is relatively short in FIG. 6B. Thus, the voltage converter 200a prevents the current IL through the inductor L1 from sharply increasing, and reduces an overshoot of the output power supply voltage VOUT.

At time t3, the current IL and the output power supply voltage VOUT are stabilized. As illustrated in FIG. 6B, in the voltage converter 200a, the approximate time required to stabilize the output power supply voltage VOUT is indicated by T2, which is shorter than T1 in FIG. 6A, above.

FIG. 7 is a block diagram illustrating a voltage converter, according to exemplary embodiments.

Referring to FIG. 7, a voltage converter 200b includes a compensation unit 210, a first control unit 220, a second control unit 230 and an output voltage generation unit 240. The voltage converter 200a may further include a ramp voltage generation unit 255, a mode selection unit 260, a feedback unit 270, a filter unit 280 and a load unit 290.

The compensation unit 210, the first control unit 220, the second control unit 230, the output voltage generation unit 240, the mode selection unit 260, the feedback unit 270, the filter unit 280 and the load unit 290 in FIG. 7 may be substantially the same as the compensation unit 210, the first control unit 220, the second control unit 230, the output voltage generation unit 240, the mode selection unit 260, the feedback unit 270, the filter unit 280 and the load unit 290 in FIG. 5, respectively. Thus, in FIG. 7, the same reference numerals will be used to refer the same or like elements in FIG. 5.

The ramp voltage generation unit 255 generates a ramp voltage VRAMP, and outputs the ramp voltage VRAMP as the second reference voltage. In this case, the voltage converter 200b may be implemented by a voltage driving scheme such that the voltage converter 200b operates based on the ramp voltage VRAMP. The ramp voltage VRAMP may have a regular waveform, such as a triangle wave or a sawtooth wave. The first control unit 220 generates the first control signal CS1 based on the compensation voltage VC and a second reference voltage (e.g., the ramp voltage VRAMP).

FIG. 8 is a diagram for describing an operation of the voltage converter of FIG. 7, according to exemplary embodiments.

Referring to FIGS. 7 and 8, the amount of load current ILOAD initially flowing through the load unit 290 is relatively small. In other words, the level of the load current ILOAD is lower than the reference current level, and the level of the output power supply voltage VOUT is higher than the predetermined voltage level. The voltage converter 200b operates in the second operation mode (e.g., the PFM mode). In the second operation mode, the compensation voltage VC has the level of the first reference voltage VREF according to the negative feedback control of the compensation unit 210.

At time t4, the load current ILOAD increases. Since the level of the load current ILOAD is higher than the reference current level (e.g., the desired maximum current level in the PFM mode), the output power supply voltage VOUT starts to decrease. During a time period from time t4 to time t5, the voltage converter 200b still operates in the second operation mode. Even when the output power supply voltage VOUT decreases, the compensation voltage VC still has the level of the first reference voltage VREF according to the negative feedback control of the compensation unit 210.

At time t5, since the level of the output power supply voltage VOUT is lower than the predetermined voltage level, the voltage converter 200b operates in the first operation mode (e.g., the PWM mode). In this case, the compensation voltage VC starts to increase from the level of the first reference voltage VREF. In FIG. 8, the difference between the compensation voltage VC and the second voltage (e.g., the ramp voltage VRAMP) is relatively small, and the time required to stabilize the compensation voltage VC is relatively short. Thus, the voltage converter 200b prevents the current IL through the inductor L1 from increasing sharply, and reduces an overshoot of the output power supply voltage VOUT.

At time t6, the current IL and the output power supply voltage VOUT are stabilized. As illustrated in FIG. 8, in the voltage converter 200b, the approximate time required to stabilize the output power supply voltage VOUT is indicated by T3.

The voltage converter 200a and the voltage converter 200b, according to exemplary embodiments, may be implemented by the current driving scheme or the voltage driving scheme. The voltage converters 200a and 200b generate the compensation voltage VC based on the output feedback voltage VFBO in the first operation mode (e.g., the PWM mode), and based on the compensation feedback voltage VFBC (e.g., the compensation voltage VC itself) in the second operation mode (e.g., the PFM mode). Even when the operation mode of the voltage converters 200a and 200b is changed from the second operation mode to the first operation mode, a sharp increase of the compensation voltage VC may be prevented. Thus, the voltage converters 200a and 200b prevent the current IL through the inductor L1 from increasing sharply, reduce the overshoot of the output power supply voltage VOUT, and effectively generate the stable output power supply voltage VOUT.

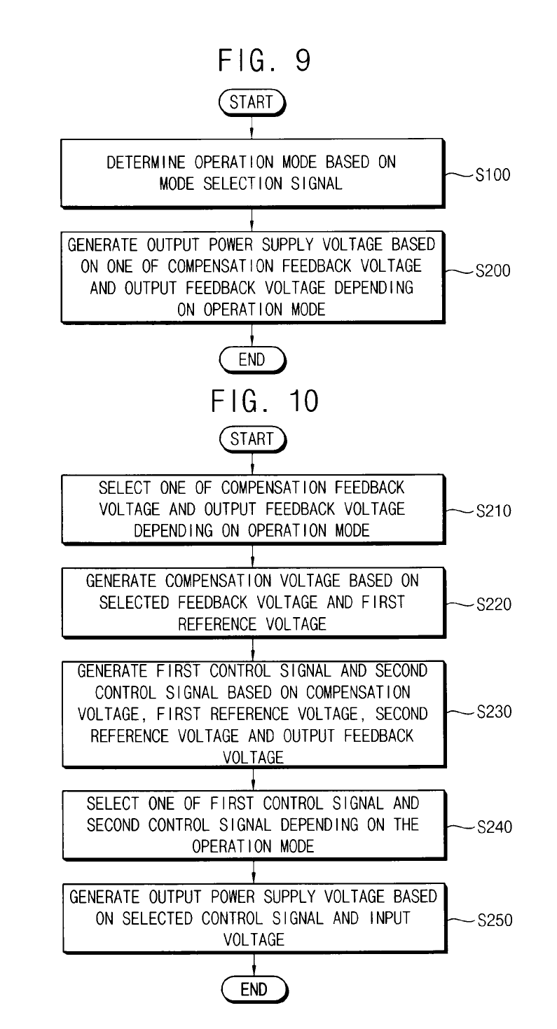

FIG. 9 is a flow chart illustrating a method of operating a voltage converter, according to exemplary embodiments.

Referring to FIGS. 1 and 9, in the method of operating the voltage converter 100, an operation mode of the voltage converter 100 is determined based on a mode selection signal MS (step S100). An output power supply voltage VOUT is generated based on one of the compensation feedback voltage VFBC and the output feedback voltage VFBO depending on the operation mode (step S200).

In an embodiment, an output terminal of the voltage converter 100 may be connected to a load unit that is driven based on the output power supply voltage VOUT. The operation mode of the voltage converter 100 may be determined depending on a level of a load current that indicates current flowing through the load unit. For example, when the level of the load current is higher than a reference current level, the mode selection signal MS has a first logic level, and the voltage converter 100 operates in a first operation mode (e.g., a PWM mode). When the level of the load current is lower than the reference current level, the mode selection signal MS has a second logic level, and the voltage converter 100 operates in a second operation mode (e.g., a PFM mode).

FIG. 10 is a flow chart illustrating an example of step S200 in FIG. 9, according to exemplary embodiments.

Referring to FIGS. 1, 9 and 10, in step S200, one of the compensation feedback voltage VFBC and the output feedback voltage VFBO is selected depending on the operation mode (step S210). The compensation voltage VC is generated based on the selected feedback voltage and the first reference voltage VREF (step S220).

The compensation feedback voltage VFBC may be the compensation voltage VC itself. The output feedback voltage VFBO may be a voltage obtained by dividing the output power supply voltage VOUT by a predetermined ratio. For example, in the first operation mode, the compensation unit 110 may select the output feedback voltage VFBO and may compare the output feedback voltage VFBO with the first reference voltage VREF to generate the compensation voltage VC. In the second operation mode, the compensation unit 110 may select the compensation feedback voltage VFBC and may compare the compensation feedback voltage VFBC with the first reference voltage VREF to generate the compensation voltage VC. In the second operation mode, the compensation unit 110 operates as a buffer with a negative feedback control, and the level of the compensation voltage VC may be substantially the same as a level of the first reference voltage VREF.

A first control signal CS1 and a second control signal CS2 are generated based on the compensation voltage VC, the first reference voltage VREF, the second reference voltage VRS and the output feedback voltage VFBO (step S230). For example, the first control unit 120 may generate the first control signal CS1 (e.g., a PWM signal) based on the compensation voltage VC and the second reference voltage VRS. The second control unit 130 may generate the second control signal CS2 (e.g., a PFM signal) based on the first reference voltage VREF and the output feedback voltage VFBO.

One of the first control signal CS1 and the second control signal CS2 are selected depending on the operation mode (step S240), and the output power supply voltage VOUT is generated based on the selected control signal and the input voltage VIN (step S250). For example, in the first operation mode, the output voltage generation unit 140 selects the first control signal CS1 to generate the output power supply voltage VOUT based on the first control signal CS1 and the input voltage VIN. In the second operation mode, the output voltage generation unit 140 selects the second control signal CS2 to generate the output power supply voltage VOUT based on the second control signal CS2 and the input voltage VIN.

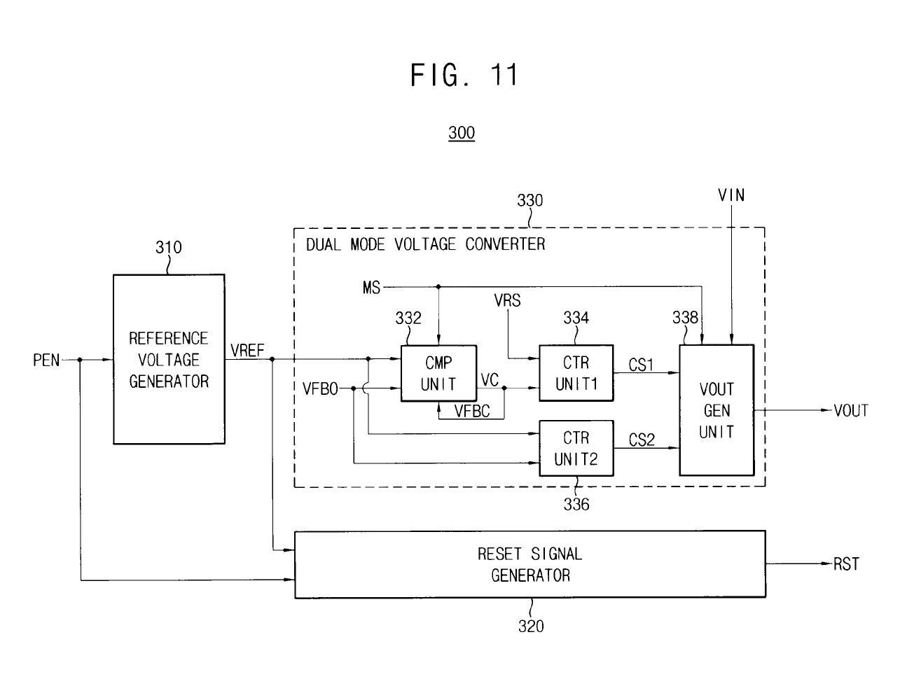

FIG. 11 is a block diagram illustrating a power management device, according to exemplary embodiments.

Referring to FIG. 11, a power management device 300 includes a reference voltage generator 310, a reset signal generator 320 and a voltage converter 330. The reference voltage generator 310 generates a first reference voltage VREF based on a power enable signal PEN. Although not illustrated in FIG. 11, the reference voltage generator 310 may be implemented with resistors used as a voltage divider for generating the first reference voltage VREF. In case a more stable reference voltage is required, the reference voltage generator 310 may be implemented with a band-gap reference voltage circuit. As known to one of ordinary skill in the art, the band-gap reference voltage circuit can provide a stable reference voltage that is insensitive to temperature variation. The band-gap reference voltage circuit may include a start-up circuit, at least one transistor, at least one resistor, etc.

The reset signal generator 320 generates a reset signal RST based on the power enable signal PEN and the first reference voltage VREF. Although not illustrated in FIG. 11, the reset signal generator 320 may include a reset enable unit, a reset disable unit and a latch unit. The reset enable unit generates a reset enable signal based on the power enable signal PEN. The reset disable unit generates a reset disable signal based on the first reference voltage VREF and the reset enable signal. The latch unit generates the reset signal RST based on the reset enable signal and the reset disable signal.

The voltage converter 330 selects one of a compensation feedback voltage VFBC and an output feedback voltage VFBO depending on an operation mode, generates a compensation voltage VC based on the selected feedback voltage and the first reference voltage VREF, generates a first control signal CS1 and a second control signal CS2 based on the compensation voltage VC, the first reference voltage VREF and the output feedback voltage VFBO, and generates an output power supply voltage VOUT based on an input voltage VIN and one of the first control signal CS1 and the second control signal CS2. The compensation feedback voltage VFBC corresponds to the compensation voltage VC, and the output feedback voltage VFBO corresponds to the output power supply voltage VOUT.

The voltage converter 330 may be the voltage converter 100 of FIG. 1, for example. The voltage converter 330 may be implemented as a dual mode voltage converter. In other words, the voltage converter 330 may operate alternatively in two modes, that is, a first operation mode (e.g., a PWM mode) and a second operation mode (e.g., a PFM mode). Thus, the power management device 300 may be implemented as a dual mode power management device.

In the depicted embodiment, the voltage converter 330 includes a compensation unit 332, a first control unit 334, a second control unit 336 and an output voltage generation unit 338. The compensation unit 332 selects one of the compensation feedback voltage VFBC and the output feedback voltage VFBO depending on the operation mode, and generates the compensation voltage VC based on the selected feedback voltage and the first reference voltage VREF. The first control unit 334 generates the first control signal CS1 based on the compensation voltage VC and a second reference voltage VRS. The second control unit 336 generates the second control signal CS2 based on the first reference voltage VREF and the output feedback voltage VFBO. The output voltage generation unit 338 selects one of the first control signal CS1 and the second control signal CS2 depending on the operation mode, and generates the output power supply voltage VOUT based on the selected control signal and the input voltage VIN.

The voltage converter 330 includes the compensation unit 332 for generating the compensation voltage VC based on the compensation feedback voltage VFBC (e.g., the compensation voltage VC itself) in the second operation mode, and based on the output feedback voltage VFBO corresponding to the output power supply voltage VOUT in the first operation mode. The compensation unit 332 operates as a buffer with a negative feedback control in the second operation mode. Accordingly, the power management device 300 including the voltage converter 330 effectively generates the stable output power supply voltage VOUT.

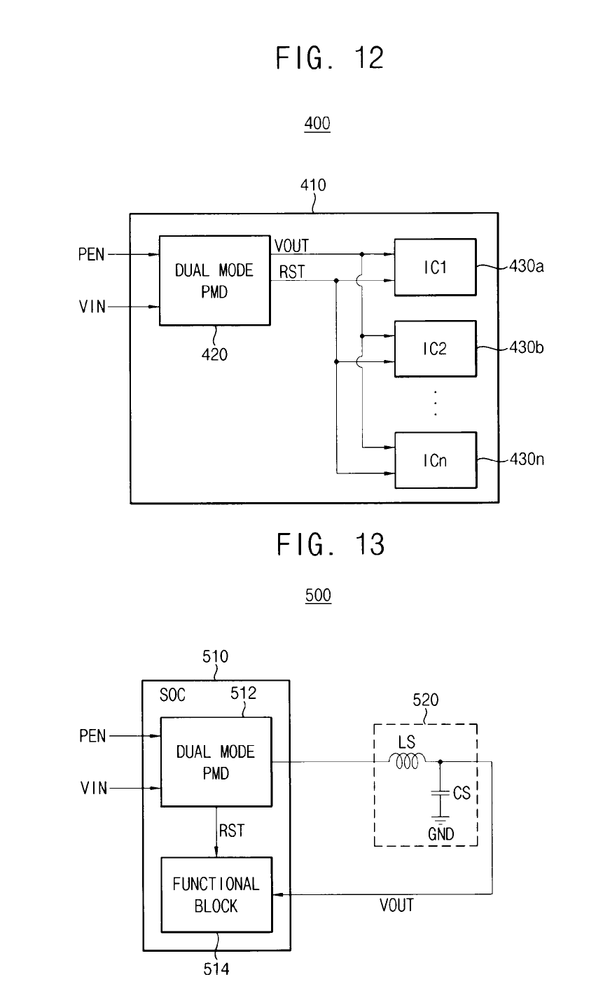

FIG. 12 is a block diagram illustrating a power management system, according to exemplary embodiments.

Referring to FIG. 12, a power management system 400 includes a power management device 420 and multiple integrated circuits 430a, 430b, . . . , 430n. The power management device 420 and the multiple integrated circuits 430a, 430b, . . . , 430n may be formed on a printed circuit board (PCB) 410.

The power management device 420 may be the power management device 300 of FIG. 11, for example, and may be implemented as a dual mode power management device. The power management device 420 generates a stable output power supply voltage VOUT based on an input voltage VIN, and generates a reset signal RST based on a power enable signal PEN. The power management device 420 may include a voltage converter. The voltage converter may be implemented as a dual mode voltage converter, and may include a compensation unit that generates a compensation voltage based on one of a compensation feedback voltage (e.g., the compensation voltage itself) and an output feedback voltage corresponding to the output power supply voltage VOUT depending on an operation mode, as discussed above. Accordingly, the power management device 420 including the voltage converter effectively generates the stable output power supply voltage VOUT.

The integrated circuits 430a, 430b, . . . , 430n maintain a reset state based on the reset signal RST until the output power supply voltage VOUT reaches a steady-state. After the output power supply voltage VOUT reaches the steady-state, the integrated circuits 430a, 430b, . . . , 430n are ready to operate and are driven based on the output power supply voltage VOUT.

FIG. 13 is a block diagram illustrating a power management system, according to other exemplary embodiments.

Referring to FIG. 13, a power management system 500 includes a system on chip (SoC) 510 and a filter 520. The SoC 510 includes a power management device 512 and a functional block 514.

The power management device 512 may be the power management device 300 of FIG. 11, for example, and may be implemented as a dual mode power management device. The power management device 512 generates a stable output current based on an input voltage VIN, and generates a reset signal RST based on a power enable signal PEN. The power management device 512 may include a voltage converter. The voltage converter may be implemented as a dual mode voltage converter, and may include a compensation unit that generates a compensation voltage based on one of a compensation feedback voltage (e.g., the compensation voltage itself) and an output feedback voltage corresponding to the output power supply voltage VOUT depending on an operation mode, as discussed above. Accordingly, the power management device 512 including the voltage converter effectively generates the stable output current.

The filter 520 may be implemented as a low-pass filter having an inductor LS and a capacitor CS. A stable output power supply voltage VOUT is induced based on the output current flowing through the inductor LS.

The functional block 514 maintains a reset state based on the reset signal RST until the output power supply voltage VOUT reaches a steady-state. After the output power supply voltage VOUT reaches the steady-state, the functional block 514 is ready to operate and is driven based on the output power supply voltage VOUT.

Although FIG. 13 illustrates an example of the power management system 500 including the filter 520 disposed outside of the SoC 510, the filter 510 alternatively may be included inside the SoC 510, without departing from the scope of the present teachings.

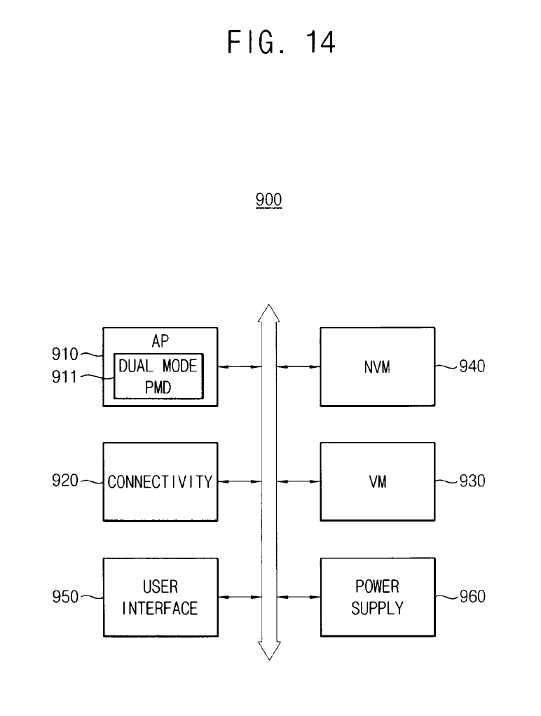

FIG. 14 is a block diagram illustrating a mobile system, according to exemplary embodiments.

Referring to FIG. 14, a mobile system 900 includes an application processor 910, a connectivity unit 920, a volatile memory device 930, a nonvolatile memory device 940, a user interface 950 and a power supply 960. According to various embodiments, the mobile system 900 may be any mobile system, such as a mobile phone, a smart phone, a personal digital assistant (PDA), a portable multimedia player (PMP), a digital camera, a portable game console, a music player, a camcorder, a video player, a navigation system, etc.

The application processor 910 may execute applications, such as an internet browser, a game application, a video player application, etc. The application processor 910 includes a power management device 911. The power management device 911 generate a stable output power supply voltage based on an input voltage, and may include a voltage converter. The voltage converter may include a compensation unit that generates a compensation voltage based on one of a compensation feedback voltage (e.g., the compensation voltage itself) and an output feedback voltage corresponding to the output power supply voltage depending on an operation mode, as discussed above. Accordingly, the power management device 911 including the voltage converter effectively generates the stable output power supply voltage. According to various embodiments, the application processor 910 may be coupled to an internal/external cache memory.

The connectivity unit 920 may interface or communicate with an external device. For example, the connectivity unit 920 may perform USB communications, Ethernet communications, near field communications (NFCs), radio frequency identification (RFID) communications, mobile telecommunications, memory card communications, and the like.

The volatile memory device 930 stores data processed by the application processor 910, and/or serves as a working memory. For example, the volatile memory device 930 may be implemented using dynamic random-access memory (DRAM), static random-access memory SRAM, mobile DRAM, and the like. The nonvolatile memory device 940 stores data to be saved even when power is removed, such as the boot image for booting the mobile system 900. For example, the nonvolatile memory device 940 may be implemented using electrically erasable programmable read-only memory (EEPROM), flash memory, phase-change random-access memory (PRAM), resistive random-access memory (RRAM), nano-floating gate memory (NFGM), polymer random-access memory (PoRAM), magnetic random-access memory (MRAM), ferroelectric random-access memory (FRAM), and the like.

The user interface 950 includes at least one input device, such as a keypad, a touch screen, and the like, and at least one output device, such as a display device, a speaker, and the like. The power supply 960 supplies the mobile system 900 with power. In various embodiments, the mobile system 900 may further include a camera image processor (CIS), and a modem, such as a baseband chipset. For example, the modem may be a modem processor that supports at least one of various communications, such as GSM, GPRS, WCDMA, HSxPA, and the like.

According to various embodiments, the mobile system 900 and/or components of the mobile system 900 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

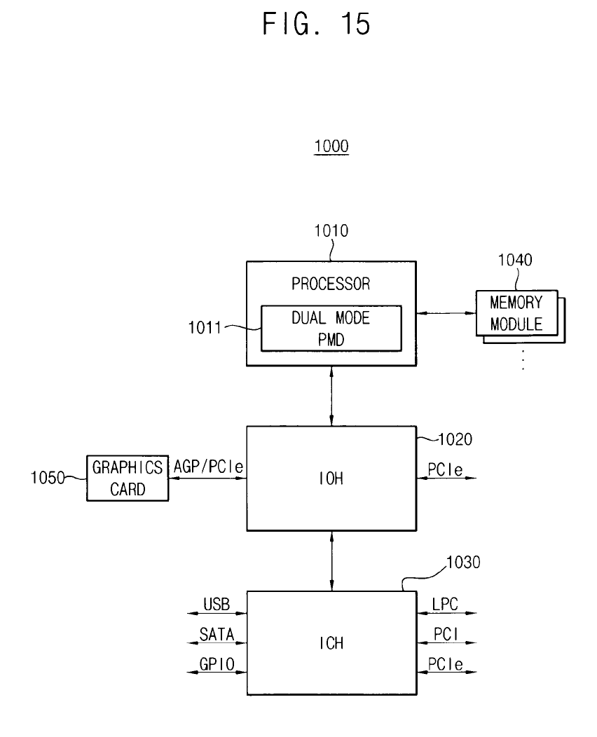

FIG. 15 is a block diagram illustrating a computing system, according to exemplary embodiments.

Referring to FIG. 15, a computing system 1000 includes a processor 1010, an input/output hub 1020, an input/output controller hub 1030, at least one memory module 1040, and a graphics card 1050. According to various embodiments, the computing system 1000 may be any computing system, such as a personal computer (PC), a server computer, a workstation, a tablet computer, a laptop computer, a mobile phone, a smart phone, a personal digital assistant (PDA), a portable multimedia player (PMP), a digital camera, a digital television, a set-top box, a music player, a portable game console, a navigation device, and the like.

The processor 1010 is configured to perform specific calculations or tasks. For example, the processor 1010 may be a microprocessor, a central process unit (CPU), a digital signal processor, and the like. The processor 1010 includes a power management device 1011. The power management device 1011 may generate a stable output power supply voltage based on an input voltage, and may include a voltage converter. The voltage converter may include a compensation unit that generates a compensation voltage based on one of a compensation feedback voltage (e.g., the compensation voltage itself) and an output feedback voltage corresponding to the output power supply voltage depending on an operation mode, as discussed above. Accordingly, the power management device 1011 including the voltage converter effectively generates the stable output power supply voltage.

According to various embodiments, the processor 1010 may include one processor core or multiple processor cores. For example, the processor 1010 may be a multi-core processor, such as a dual-core processor, a quad-core processor, a hexa-core processor, and the like. Although FIG. 15 illustrates an example of the computing system 1000 including one processor 1010, the computing system 1000 according to various embodiments may include one or more processors, without departing from the scope of the present teachings.

The processor 1010 may include a memory controller (not illustrated) that controls operation of the memory module 1040. The memory controller included in the processor 1010 may be referred to as an integrated memory controller (IMC), for example. A memory interface between the memory module 1040 and the memory controller may be implemented using one channel having multiple signal lines, or using multiple channels. Each channel may be coupled to at least one memory module 1040. In various embodiments, the memory controller may be included in the input/output hub 1020. The input/output hub 1020 including the memory controller may be referred to as a memory controller hub (MCH).

The input/output hub 1020 manages data transfer between the processor 1010 and various devices, such as the graphics card 1050. The input/output hub 1020 may be coupled to the processor 1010 via one of various interfaces, such as a front side bus (FSB), a system bus, a HyperTransport, a lightning data transport (LDT), a QuickPath interconnect (QPI), a common system interface (CSI), and the like. Although FIG. 15 illustrates an example of the computing system 1000 including one input/output hub 1020, in various embodiments, the computing system 1000 may include multiple input/output hubs, without departing from the scope of the present teachings.

The input/output hub 1020 provides various interfaces with devices. For example, the input/output hub 1020 may provide an accelerated graphics port (AGP) interface, a peripheral component interface-express (PCIe), a communications streaming architecture (CSA) interface, and the like.

The graphics card 1050 is coupled to the input/output hub 1020 via the AGP or the PCIe, for example. The graphics card 1050 controls a display device (not shown) for displaying an image. The graphics card 1050 may include an internal processor and an internal memory to process the image. In various embodiments, the input/output hub 1020 may include an internal graphics device along with or instead of the graphics card 1050. Such an internal graphics device may be referred to as integrated graphics, and an input/output hub including the memory controller and the internal graphics device may be referred to as a graphics and memory controller hub (GMCH).

The input/output controller hub 1030 performs data buffering and interface arbitration to efficiently operate various system interfaces. The input/output controller hub 1030 may be coupled to the input/output hub 1020 via an internal bus. For example, the input/output controller hub 1030 may be coupled to the input/output hub 1020 via one of various interfaces, such as a direct media interface (DMI), a hub interface, an enterprise Southbridge interface (ESI), PCIe, etc. The input/output controller hub 1030 may provide various interfaces with peripheral devices. For example, the input/output controller hub 1030 may provide a universal serial bus (USB) port, a serial advanced technology attachment (SATA) port, a general purpose input/output (GPIO), a low pin count (LPC) bus, a serial peripheral interface (SPI), a PCI, a PCIe, etc.

In various embodiments, the processor 1010, the input/output hub 1020 and the input/output controller hub 1030 may be implemented as separate chipsets or separate integrated circuits. In other embodiments, at least two of the processor 1010, the input/output hub 1020 and the input/output controller hub 1030 may be implemented as one chipset.

The above described embodiments may be applied to an integrated circuit and/or an electronic system that require a stable power supply voltage. For example, the above described embodiments may be applied to a power management device, a power management system, an application processor, a microprocessor, a CPU, an application-specific integrated circuit (ASIC), a mobile SoC, a multimedia SoC, a smartcard, and the like.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A voltage converter, comprising:
a compensation unit configured to select one of a compensation feedback voltage and an output feedback voltage depending on an operation mode, and to generate a compensation voltage based on the selected feedback voltage and a first reference voltage, the compensation feedback voltage corresponding to the compensation voltage, and the output feedback voltage corresponding to an output power supply voltage;
a first control unit configured to generate a first control signal based on the compensation voltage and a second reference voltage;
a second control unit configured to generate a second control signal based on the first reference voltage and the output feedback voltage; and
an output voltage generation unit configured to select one of the first control signal and the second control signal depending on the operation mode, and to generate the output power supply voltage based on the selected control signal and an input voltage.

2. The voltage converter of claim 1, wherein the operation mode comprises a first operation mode and a second operation mode,
wherein the compensation unit is configured to select the output feedback voltage and to compare the output feedback voltage with the first reference voltage to generate the compensation voltage in the first operation mode, and
wherein the compensation unit is configured to select the compensation feedback voltage and to compare the compensation feedback voltage with the first reference voltage to generate the compensation voltage in the second operation mode.

3. The voltage converter of claim 2, wherein the output voltage generation unit is configured to select the first control signal and to generate the output power supply voltage based on the first control signal and the input voltage in the first operation mode, and
wherein the output voltage generation unit is configured to select the second control signal and to generate the output power supply voltage based on the second control signal and the input voltage in the second operation mode.

4. The voltage converter of claim 2, wherein an output terminal of the output voltage generation unit is connected to a load unit driven based on the output power supply voltage, and
wherein the voltage converter operates in the first operation mode when a level of a load current is higher than a reference current level, and the voltage converter operates in the second operation mode when the level of the load current is lower than the reference current level, the load current indicating a current flowing through the load unit.

5. The voltage converter of claim 4, wherein the first operation mode is a pulse width modulation (PWM) mode, and the first control signal is a PWM signal.

6. The voltage converter of claim 5, wherein the second operation mode is a pulse frequency modulation (PFM) mode, and the second control signal is a PFM signal.

7. The voltage converter of claim 1, wherein the compensation unit comprises:
a selection unit configured to select one of the compensation feedback voltage and the output feedback voltage based on a mode selection signal; and
a frequency compensation unit configured to compare the selected feedback voltage with the first reference voltage, and to perform a frequency compensation operation on the selected feedback voltage to generate the compensation voltage.

8. The voltage converter of claim 7, further comprising:
a mode selection unit configured to generate the mode selection signal based on a current flowing through the output voltage generation unit.

9. The voltage converter of claim 1, wherein the first control unit comprises:
a comparison unit configured to compare the compensation voltage with the second reference voltage to generate a comparison signal; and
a latch unit configured to generate the first control signal based on a clock signal and the comparison signal.

10. The voltage converter of claim 9, wherein the second reference voltage has an irregular waveform changing based on a current flowing through the output voltage generation unit.

11. The voltage converter of claim 9, further comprising:
a sensing unit configured to detect a current flowing through the output voltage generation unit to generate a sensing voltage, and configured to output the sensing voltage as the second reference voltage.

12. The voltage converter of claim 9, further comprising:
a ramp voltage generation unit configured to generate a ramp voltage, and to output the ramp voltage as the second reference voltage.

13. The voltage converter of claim 1, wherein the output voltage generation unit comprises:
a driving unit configured to select one of the first control signal and the second control signal depending on the operation mode to generate gate driving signals;
an amplification unit configured to amplify the gate driving signals to generate amplified gate driving signals; and
an output unit configured to convert the input voltage into the output power supply voltage in response to the amplified gate driving signals.

14. A power management device, comprising:
a reference voltage generator configured to generate a reference voltage based on a power enable signal;
a reset signal generator configured to generate a reset signal based on the power enable signal and the reference voltage; and
a voltage converter configured to provide an output power supply voltage, the voltage converter comprising:
a compensation unit configured to select one of a compensation feedback voltage and an output feedback voltage depending on an operation mode, and to generate a compensation voltage based on the selected feedback voltage and the reference voltage, the compensation feedback voltage corresponding to the compensation voltage, and the output feedback voltage corresponding to an output power supply voltage;
control units configured to generate first and second control signals based on the compensation voltage, the reference voltage and the output feedback voltage; and
an output voltage generation unit configured to generate the output power supply voltage based on an input voltage and a selected one of the first and second control signals.

15. The power management device of claim 14, wherein the control units comprise a first control unit configured to generate the first control signal based on the compensation voltage and a second reference voltage, and a second control unit configured to generate the second control signal based on the reference voltage and the output feedback voltage.

16. The power management device of claim 14, wherein the operation mode comprises a first operation mode and a second operation mode,
wherein the compensation unit is configured to select the output feedback voltage and to compare the output feedback voltage with the reference voltage to generate the compensation voltage in the first operation mode, and
wherein the compensation unit is configured to select the compensation feedback voltage and to compare the compensation feedback voltage with the reference voltage to generate the compensation voltage in the second operation mode.

17. A method of converting an input voltage to an output supply voltage to be provided to a load unit, the method comprising:
determining an operation mode based on a mode selection signal, the mode selection signal being generated in response to a level of load current flowing through the load unit;
selecting one of a compensation feedback voltage and an output feedback voltage depending on the operation mode, the compensation feedback voltage corresponding to a compensation voltage, and the output feedback voltage corresponding to the output supply voltage; and
generating the output supply voltage based on the selected one of the compensation feedback voltage and the output feedback voltage and the input voltage.

18. The method of claim 17, wherein generating the output supply voltage based on the selected one of the compensation feedback voltage and the output feedback voltage comprises:
generating the compensation voltage based on a first reference voltage and the selected one of the compensation feedback voltage and the output feedback voltage;
generating first and second control signals based on the compensation voltage, the first reference voltage and a second reference voltage;
selecting one of the first and second control signals depending on the operation mode; and
generating the output supply voltage based on the selected control signal and the input voltage.

19. The method of claim 18, wherein generating first and second control signals comprises:
generating the first control signal based on the compensation voltage and the second reference voltage, the first control signal being a pulse width modulation (PWM) signal; and
generating the second control signal based on the first reference voltage and the output feedback voltage, the second control signal being a pulse frequency modulation (PFM) signal.

20. The method of claim 19, wherein when the level of the load current is higher than a reference current level, the operation mode is a PWM mode and the first control signal is selected, and when the level of the load current is lower than the reference current level, the operation mode is a PFM mode and the second control signal is selected.
